(19) United States
(12) Patent Application Publication
(10) Pub. No.: US 2022/0308365 A1
(43) Pub. Date: Sep. 29, 2022

(54) EYEWEAR LENSES

(71) Applicant: Alvin P Perkinson, New Smyrna Beach, FL (US)

(72) Inventor: Alvin P Perkinson, New Smyrna Beach, FL (US)

(21) Appl. No.: 17/706,271

(22) Filed: Mar. 28, 2022

Related U.S. Application Data
(60) Provisional application No. 63/166,645, filed on Mar. 26, 2021.

(51) Int. Cl. G02C 7/10

(52) U.S. Cl. CPC G02C 7/104; G02C 7/108

(57) ABSTRACT

An eyewear lens assembly is characterized by at least a first specific light transmittance, a second specific light transmittance, and an overall visible light transmittance. The first specific light transmittance is focused on the blue spectrum up through, and including, about 440 nm to 445 nm. The light transmittance should reflect a reduction of light in the range of 95%-100%. The second specific light transmittance is focused on the yellow spectrum, around 580 nm. The second specific light transmittance should reflect a reduction of light in the range of 92%-95%. The overall visible light transmittance can be tuned according to the desired use case of the eyewear and can range from about and 80% reduction to about a 90% reduction in visible light.

### CLAIM OF PRIORITY

The present application is based on, and a claim of priority is made under 35 U.S.C. Section 119(e) to a provisional patent application that is currently pending in the U.S. Patent and Trademark Office, namely, that having Ser. No. 63/166,645 and a filing date of Mar. 26, 2021, and which is incorporated herein by reference.

### BACKGROUND OF THE INVENTION

### Field of the Invention

The invention is directed to sunglass lenses which are particularly suitable for water sports and other activities, such as fishing. The inventive lenses reduce and filter certain wavelengths of light to assist visibility for these activities.

### Description of the Related Art

In the field of eyewear for watersports and water-based activities, glare is typically a primary concern given the suns propensity to reflect off the surface of the water. It has been a subject of research and advancement in this field to reduce glare by producing lenses which reduce light transmission in the yellow spectrum. Separately, blue light has been identified has a source of harm or irritation to the human eye. It is understood that blue light suppresses bodys ability to produce melatonin and can cause eye diseases like macular degeneration. In the field of eyewear for watersports and water-based activities, blue light has been identified as a source of haze, which reduces clarity.

The present invention builds upon these and other principles in the art to provide a lens with superior performance for watersports, such as fishing, and other water-based activities.

### SUMMARY OF THE INVENTION

The present invention is directed to improved lenses or lens assemblies, which can be made from a base lens element and other layers, coatings, or films, such as mirrored coatings, anti-reflective coatings, and oleophobic coatings. In any event, one aim of the present invention is to produce a lens that filters both blue and yellow light to a significant degree, while reducing all other visible light to a lesser degree. The inventor has determined that this combination of a targeted reduction in both the blue and yellow spectrums yields lenses which are particularly suitable for watersports, such as fishing, as the lenses provide superior clarity on the water and allow a user to see through the water. The inventive lenses also reduce blur, glare, and haze that commonly occurs during bright daylight on the open water. Additionally targeted reduction of blue light reduces eye fatigue.

The main principles of the present invention, i.e., a targeted reduction of blue and yellow light at specific wavelength and wavelength ranges, can be applied to various different lens assemblies in order to achieve an overall reduction in visible light transmission, to accommodate various conditions, but still provide the wearer the benefit of the targeted reductions in the blue and yellow wavelengths. By way of example, an overall visible light reduction of 80%-90% can be achieved (i.e., only permitting 10%-20% of visible light to pass through the lens).

These and other objects, features and advantages of the present invention will become clearer when the drawings as well as the detailed description are taken into consideration.

### BRIEF DESCRIPTION OF THE DRAWINGS

For a fuller understanding of the nature of the present invention, reference should be had to the following detailed description taken in connection with the accompanying drawings in which:

FIG. 1 is a schematic showing various base lens and mirror coating combinations for a plurality of lenses according to one embodiment of the present invention.

Like reference numerals refer to like parts throughout the several views of the drawings.

### DETAILED DESCRIPTION OF THE PREFERRED EMBODIMENT

In the most preferred embodiment, the lenses of the present invention are characterized by at least a first specific light transmittance which reduces light up to the 440 nm wavelength by at least 95%, but most preferably 100%. It is known that the lower limit of visibility in the human eye occurs generally around 380 nm, i.e. the violet spectrum. However, it is also known and desired to reduce light in the ultraviolet spectrum, or more specifically the UV-A and UV-B spectrum, which ranges down to about 280 nm. Thus, a most preferred embodiment of the inventive lens may alternatively have a first specific light transmittance which reduces light from about 280 nm to about 440 nm by at least 95%, and most preferably 100%. The first specific light transmittance may also extend from about 440 nm to about 445 nm and is characterized by a reduction of 95% in that range. The lens assemblies of the present invention are also characterized by a second specific light transmittance which reduces light at or around the 580 nm wavelength by 92%-95% as well. It is this combined and targeted reduction of light in both the blue (440 nm-445 nm) and yellow (580 nm) spectrums that gives the inventive lens assemblies superior performance on the water and for water sports.

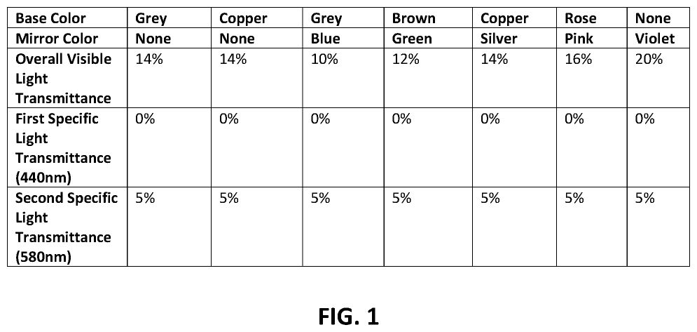

Overall visible light transmission in all other wavelengths can be adjusted depending upon the intended use. This can be achieved with various additives to the base lens element, such as dyes or rare earth elements, depending upon the composition of the base lens element (e.g., glass or polymer). Mirrored coatings or films are also suitable. By way of example, lenses to be used in the open ocean on bright sunny days will allow 10%-11% visible light transmission. At the other end of the spectrum, lenses to be used in the shade or on overcast days can be configured to allow 18%-20% total visible light transmission. The combination of base color and mirror color for the lens can be varied to achieve the desired level of visible light transmission. As depicted in FIG. 1, in one embodiment, the base lens may be colored grey to provide an overall visible light transmittance of no more than 14% of light in the visible light spectrum. Additionally, the base lens element may be colored copper to provide an overall visible light transmittance of no more than 14% of light in the visible light spectrum. A violet base lens element may be used to achieve an overall visible light transmittance of no more than 20% of light in the visible light spectrum. In another embodiment a grey colored base lens element may be combined with a blue mirrored coating layer to achieve an overall visible light transmittance of no more than 10% of light in the visible spectrum. By way of further example, a brown base lens element may be combined with a green mirrored coating layer to achieve an overall visible light transmittance of no more than 12% of light in the visible light spectrum. Additionally, a rose base lens element may be combined with a pink mirrored coating layer to achieve a visible light transmittance of no more than 16% of light in the visible light spectrum.

The lens assemblies may include a plurality of other layers in addition to the base lens element, such as anti-reflective coatings, oleophobic coatings, mirror films, polarizing films, and other layers. In a preferred embodiment, the anti-reflective coating is blue. Additionally, in a preferred embodiment, the oleophobic coating is applied to both sides of the lens assembly.

Since many modifications, variations and changes in detail can be made to the described embodiments of the invention, it is intended that all matters in the foregoing description and shown in the accompanying drawings be interpreted as illustrative and not in a limiting sense. Thus, the scope of the invention should be determined by the appended claims and their legal equivalents.

What is claimed is:

1. An eyewear lens assembly comprising:
at least one base lens element and one or more additional layers;
the eyewear lens assembly characterized by at least a first specific light transmittance, a second specific light transmittance, and an overall visible light transmittance;
said first specific light transmittance permitting no more than 5% of light in the wavelengths from about 440 nm to about 445 nm to pass through the eyewear lens assembly; and
said second specific light transmittance permitting no more than 8% of light in the wavelength of about 580 nm to pass through the eyewear lens assembly.

2. The eyewear lens as recited in claim 1 wherein said first specific light transmittance at about 440 nm is less than 1%.

3. The eyewear lens as recited in claim 1 wherein said first specific light transmittance at about 440 nm is less an 0.5%.

4. The eyewear lens as recited in claim 1 wherein said first specific light transmittance at about 440 nm is 0.0%.

5. The eyewear lens as recited in claim 1 wherein said first specific light transmittance is no more than 5% from about 280 nm to about 445 nm.

6. The eyewear lens assembly as recited in claim 1 wherein said base lens element is colored grey and said overall visible light transmittance is no more than 14% of light in the visible light spectrum.

7. The eyewear lens assembly as recited in claim 1 wherein said base lens element is colored copper and said overall visible light transmittance is no more than 14% of light in the visible light spectrum.

8. The eyewear lens assembly as recited in claim 1 further comprising at least one mirror coating layer.

9. The eyewear lens assembly as recited in claim 8 wherein said base lens element is colored grey, said mirror coating layer is colored blue, and said overall visible light transmittance is no more than 10% of light in the visible light spectrum.

10. The eyewear lens assembly as recited in claim 8 wherein said base lens element is colored brown, said mirror coating layer is colored green, and said overall visible light transmittance is no more than 12% of light in the visible light spectrum.

11. The eyewear lens assembly as recited in claim 8 wherein said base lens element is colored copper, said mirror coating layer is colored silver, and said overall visible light transmittance is no more than 14% of light in the visible light spectrum.

12. The eyewear lens assembly as recited in claim 8 wherein said base lens element is colored rose, said mirror coating layer is colored pink, and said overall visible light transmittance is no more than 16% of light in the visible light spectrum.

13. The eyewear lens assembly as recited in claim 8 wherein said mirror coating layer is colored violet and said overall visible light transmittance is no more than 20% of light in the visible light spectrum.

14. A sunglass lens comprising:
a lens assembly configured to reduce light transmission up to the 445 nm wavelength by at least 95% and around the 580 nm wavelength by at least 92%;
said lens assembly further configured to reduce overall light transmission in the visible spectrum by at least 80%.

15. The sunglass lens as recited in claim 14 further comprising a reduction of light transmission between 280 nm and 445 nm by at least 95%.

16. The sunglass lens as recited in claim 14 further comprising a reduction of light transmission between 280 nm and 445 nm by 100%.

17. The sunglass lens as recited in claim 14 further comprising an overall reduction of light transmission in the visible spectrum by at least 85%.

18. The sunglass lens as recited in claim 14 further comprising an overall reduction of light transmission in the visible spectrum by at least 88%.

19. The sunglass lens as recited in claim 14 further comprising an overall reduction of light transmission in the visible spectrum by at least 90%.
